(19) United States
(12) Patent Application Publication
(10) Pub. No.: US 2025/0207653 A1
(43) Pub. Date: Jun. 26, 2025

(54) TEMPERATURE-DEPENDENT DAMPING OF VIBRATIONS

(71) Applicant: AUDI AG, Ingolstadt (DE)

(72) Inventors: Markus THURMEIER, Adlkofen (DE); Francisco TRIGUEROS MORERA DE LA VALL, München (DE)

(21) Appl. No.: 18/988,525

(22) Filed: Dec. 19, 2024

(30) Foreign Application Priority Data
Dec. 21, 2023 (DE) 102023136214.3

(51) Int. Cl. F16F 9/52

(52) U.S. Cl. CPC F16F 9/52; F16F 2222/12; F16F 2224/04; F16F 2228/066

(57) ABSTRACT

An arrangement for at least partially adapting a damping property of a damping device and/or a component is disclosed, and may include at least one component and at least one damping device integrated into the at least one component or connected to the at least one component. The at least one damping device may have a wall which at least partially defines a closable cavity. At least one cavity filling may be arranged in the cavity. The cavity filling may be configured to cause a pressure change and/or a mechanical movement in the cavity as a function of a temperature change. Furthermore, a method is disclosed.

### BACKGROUND

### Technical Field

The disclosure relates to an arrangement for at least partially adapting a damping property and a method for damping mechanical vibrations of a component as a function of a temperature.

### Description of the Related Art

Mechanical dampers are used in various technical areas to dampen vibrations of driven machines or from power transmission or to create mechanical decoupling. For example, combustion engines and, depending on the configuration, transmissions are mechanically decoupled from other components by mechanical vibration dampers made of an elastomer or by gas dampers. The dampers or damping measures are usually adapted to a specific frequency or frequency band of the vibrations.

For driven machines in the form of electric motors, damping measures in the form of washers made of an elastomer are also known. Due to the significantly larger speed range of electric motors compared to combustion engines, the damping measures used in electric motors may often only effectively compensate for a portion of the vibrations and frequencies generated. In addition, high-frequency acoustic noise may occur in electric motors, which may depend not only on the set speed of the electric motor but also on the temperature of the electric motor. Such temperature fluctuations may also have a detrimental effect on the damping measures of the electric motor, since conventional vibration dampers made of an elastomer regularly become softer with increasing temperature.

From U.S. Patent Application Publication No. 2021/0014958A1 an arrangement is known by which a thermal decoupling between a machine and an electrical component is implemented.

EP4223994A1 describes an arrangement with a plate for sound absorption. Due to a thermally conductive connection of the plate to a component, the plate can be used for cooling.

DE102004002696A1 describes a system for shielding electromagnetic waves generated by electrical circuits and systems.

### BRIEF SUMMARY

The present disclosure provides an arrangement and a method by which a mechanical vibration characteristic of a vibrating component may be dampened as a function of temperature.

The arrangement according to the present disclosure may be configured to at least partially adapt one or more damping properties of the damping device and of a component or part to a temperature to enable damping of vibrations of a component as a function of temperature. The term “partially” may, for example, refer to damping some of the vibrations of a frequency spectrum and/or to damping some of an amplitude spectrum.

The component may be a component or part which generates oscillations or vibrations itself and/or at least partially transmits vibrations from another source.

The arrangement may have at least one component and at least one damping device. The damping device may be integrated into the component or may be connected to the component. The at least one damping device may have a wall which forms a closable cavity and at least partially delimits this cavity. Furthermore, at least one cavity filling may be provided which is arranged in the cavity. The cavity filling may be configured to enable a pressure change and/or a mechanical movement in the cavity as a function of a temperature change.

According to a further aspect of the present disclosure, a damping device may be provided which may be attached to a component in a materially bonded and/or mechanical manner. The damping device may have at least one wall which may form and at least partially delimit a cavity. A cavity filling in the form of a phase change material may be arranged in the cavity. The cavity filling may fill the cavity at least partially or in its entirety.

According to a further aspect of the present disclosure, a method may be provided for damping mechanical vibrations of a component as a function of a temperature. A component that generates and/or transmits mechanical vibrations may be heated or cooled directly or indirectly. Such temperature changes may arise due to self-heating or self-cooling or may be brought about by other components.

In one step, at least one cavity filling of a damping device connected to the component, which may be arranged in a closed cavity, may be subjected to a temperature by the component and/or an environment of the component.

Subjecting the cavity filling to a temperature may cause at least a partial change of a phase state of the cavity filling. The cavity filling or a material of the cavity filling may partially experience a change in phase state depending on the mass or volume. Alternatively or additionally, the change in phase state may at least be initiated, causing, for example, a change in the viscosity of the cavity filling.

By changing the phase state of the cavity filling, at least one damping property of the damping device may be changed due to a pressure change and/or a mechanical movement of the cavity filling in the cavity.

The method according to the present disclosure thus may enable the temperature-dependent change of the cavity filling in the cavity, through which the damping device is stiffened due to an increase in pressure in order to stiffen a surface or a section of the component. Alternatively, a reduction in pressure in the cavity may be implemented so that the cavity filling in the cavity becomes movable and can absorb vibrations due to a relative movement in the cavity.

The arrangement and the method may enable special materials in the form of cavity fillings to be attached mechanically or by adhesion to one or more parts or components, which change their damping properties at certain temperatures. Such embodiments may enable the acoustic characteristic of, for example, an electrical machine to be optimized during operation and the transmission of vibrations to surrounding components to be avoided. Furthermore, resonance frequencies or the occurrence of resonances during operation of the electrical machine may be avoided because the frequency band shifts due to the at least one damping device.

The cavity filling may comprise one or more materials. At least one of these materials may be a phase change material. This phase change material may be adapted to a temperature range of the component, for example, an operating temperature. Such phase change materials may, for example, have salts such as sodium acetate, and/or organic compounds such as paraffins.

The damping device may be integrated inside or into the component during manufacture or beforehand, or the damping device may be attached to the component later or on the outside. The damping device may be connected to the component by any of gluing, welding, soldering, riveting, screwing, and the like.

In some embodiments, the cavity filling may be in contact directly with the component in order to register the temperature change on the component as quickly as possible. Alternatively, the cavity filling may be spaced apart from the component in order to reduce or adapt the impact of the component temperature, for example the rate of the temperature change, on the cavity filling.

According to some embodiments, the cavity filling may be configured as a phase change material or may have at least one phase change material. Alternatively or additionally, the cavity filling may be configured as a bimetal or may have a bimetal. Such embodiments may enable the cavity filling to generate a pressure change within the cavity due to a change in a phase state. This may enable the damping device to stiffen the section of the component, for example. Using the cavity filling in the form of a bimetal may result in a similar effect, whereby the bimetal may bend at a predefined temperature in such a way that the wall and the section of the component are structurally reinforced.

Alternatively, at a predefined temperature, the cavity filling may create a pressure reduction in the cavity or be loose in the cavity, whereby a relative movement of the cavity filling in the cavity may lead to an adaptation of the damping properties of the damping device.

In further embodiments, the wall of the damping device may be configured in one or in several parts. Preferably, the parts of the wall may be connected to one another by way of a fastening device and/or are materially bonded. Such embodiments may enable the wall to comprise several parts connected to one another and thus encapsulate the cavity filling in the cavity.

In some embodiments, the wall, which may be configured as a protective layer for the cavity filling, may also be used to conduct heat. The wall may therefore be made of metal or plastic.

According to some embodiments, the parts of the wall may close the at least one cavity with the introduced cavity filling in a fluid-tight manner. Such embodiments may enable a stiffening of the damping device by an increase in the volume of the cavity filling with a resulting increase in pressure in the cavity.

According to further exemplary embodiments, the wall of the damping device may be connected to at least one section of the component. As a result, for example, an external section of the component may be partially exposed to the damping device.

In some embodiments, the at least one cavity with the introduced cavity filling may be closed in a fluid-tight manner by an interaction of the wall of the damping device and the section of the component. In such embodiments, the cavity of the damping device may be configured to be open and only closed in a fluid-tight manner after being fastened to the section of the component. Such embodiments may enable the damping device to be manufactured particularly cost-efficiently and quickly.

According to further embodiments, the wall of the damping device may have a peripheral edge which is brought into contact with a section of the component and/or with a closure section of the damping device by way of a fastening device and/or by a material bond. The closure section of the damping device may be oriented towards the component or away from the component. A cavity which is at least partially open through the wall may be closed in a fluid-tight manner by the closure section. Such embodiments may ease introducing or inserting the cavity filling into the cavity and then hermetically closing the cavity by the closure section.

According to further exemplary embodiments, the wall of the damping device may be connected directly to the component by way of an adhesive layer or adhesive film. In some embodiments, the wall of the damping device may be connected indirectly to the component by way of an adhesive layer or adhesive film via the closure section. Such embodiments may enable the damping device to be subsequently attached to a surface or section of the component. Components in the form of electric motors, transmissions and the like may thus be subsequently equipped with temperature-dependent vibration damping by the at least one damping device. The damping device may be configured with a fluid-tight cavity only through interaction with the component or even without the component. Such damping devices may advantageously be partially applied to critical areas of the at least one component.

According to some embodiments, a damping device may be fastened to an external section of the component by way of adhesive pads, which may comprise three or more layers, for example. The section of the component may be configured as a surface or part of a surface of the component, for example. Such embodiments may enable the damping device to be spaced apart from the component in order to reduce, for example, the impact of the temperature change on the component on the cavity filling.

According to further embodiments, the at least one cavity filling may be configured to at least partially undergo a phase transition from liquid to solid, from solid to liquid, from liquid to gaseous, from gaseous to liquid, from solid to gaseous or from gaseous to solid due to a temperature change. The cavity filling may thus comprise one or more materials which may be liquid, pasty, bulk material-like or gaseous. A change in the phase state of the cavity filling may result in a change in the viscosity or at least in a possible vibration characteristic.

According to further embodiments, the at least one cavity filling may be configured to cause a pressure increase or pressure decrease due to a change in a phase state in the fluid-tightly closed cavity. Such embodiments may enable actively adaptation of the damping properties as a function of the temperature in the component or the external boundary conditions, such as, for example, ambient temperature, crash, driving dynamics and the like. The cavity filling, configured for example as an additional layer, may change the phase when the temperature changes and, for example, increase the stiffness of the system because the pressure in the cavity increases. The additional layer may advantageously be encapsulated for this purpose in order to prevent the cavity filling from leaking or evaporating.

According to further embodiments, the at least one cavity filling may have at least one additive. The at least one additive may be configured in the form of heat-conducting particles. The cavity filling may thus comprise several components that also include heat-conductive particles. In addition, further additives for regulating or adapting the viscosity, such as binders or solvents, may be provided. The cavity filling may also comprise several different phase change materials in order to set a temperature range within which the cavity filling can initiate or completely execute the change in phase state.

### BRIEF DESCRIPTION OF THE SEVERAL VIEWS OF THE DRAWINGS

FIG. 1 shows an arrangement according to a first exemplary embodiment according to the present disclosure.

FIG. 2 shows the arrangement of FIG. 1 to illustrate a method according to an exemplary embodiment according to the present disclosure.

FIG. 3 shows an arrangement according to a second exemplary embodiment according to the present disclosure.

FIG. 4 shows an arrangement according to a third exemplary embodiment according to the present disclosure.

### DETAILED DESCRIPTION

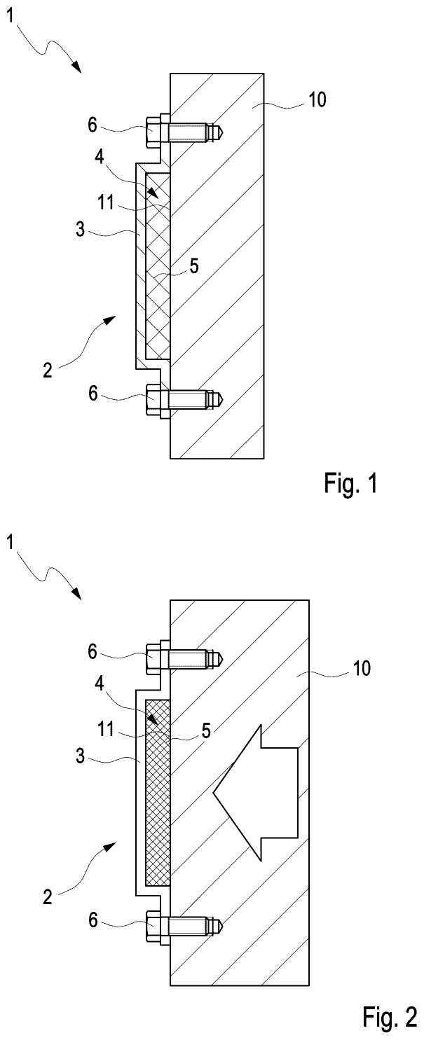

FIG. 1 shows an arrangement 1 according to a first exemplary embodiment according to the present disclosure. Arrangement 1 may have at least one component 10 and at least one damping device 2.

Component 10 may be an electric motor or a transmission, for example. In general, component 10 may be configured as a component that can generate or transmit vibrations during operation. Such vibrations may be disruptive and/or damaging depending on the frequency range. Currently, no additional damping measures which adapt to the temperature of component 10 and then change the damping properties may be attached to such components 10 when available on the market. However, such measures are necessary because different problems may arise in series production due to vibrations, such as acoustic noise, etc. Such vibrations may be reduced or avoided as a function of temperature using a damping device 2.

Damping device 2 may be integrated into component 10 or may be connected to component 10. In the illustrated exemplary embodiment, damping device 2 is configured as a subsequent solution and is mechanically fastened to an external section 11 of component 10.

The at least one damping device 2 may have a wall 3 which forms a closable cavity 4 and at least partially delimits this cavity 4.

Wall 3 may also be a part of a mechanical element or component 10, which may at least partially define cavity 4.

Furthermore, at least one cavity filling 5 may be provided, which may be arranged in cavity 4. Cavity filling 5 may have at least one phase change material. For example, cavity filling 5 may fill cavity 4 in its entirety.

Damping device 2 may be screwed to component 10 via wall 3. Section 11 of component 10, upon interaction with wall 3, may enable a fluid-tight closure of cavity 4. For this purpose, wall 3 may be screwed to component 10 by way of screw connections 6.

FIG. 2 shows arrangement 1 of FIG. 1 to illustrate a method according to an exemplary embodiment according to the present disclosure. In particular, it is illustrated that a phase state of cavity filling 5 or of the phase change material of cavity filling 5 changes at a certain temperature. This may, for example, cause the pressure in cavity 4 to increase. The increasing pressure may at least partially change the stiffness or generally at least one property of section 11 of component 10. Such embodiments may enable an adaptation and optimization of the vibration characteristic of component 10.

The phase state of the phase change material of cavity filling 5 may change due to heating of component 10. The heat transfer from component 10 into damping device 2 is illustrated by the arrow. The heat transfer may cause at least a partial change in a phase state of cavity filling 5. Cavity filling 5 or a material of cavity filling 5 may partially experience a change in phase state depending on the mass or volume. Alternatively or additionally, the change in phase state may at least be initiated, which causes, for example, a change in the viscosity of cavity filling 5.

By changing the phase state of cavity filling 5, at least one damping property of damping device 2 may be changed due to a pressure change and/or a mechanical movement of cavity filling 5 in cavity 4.

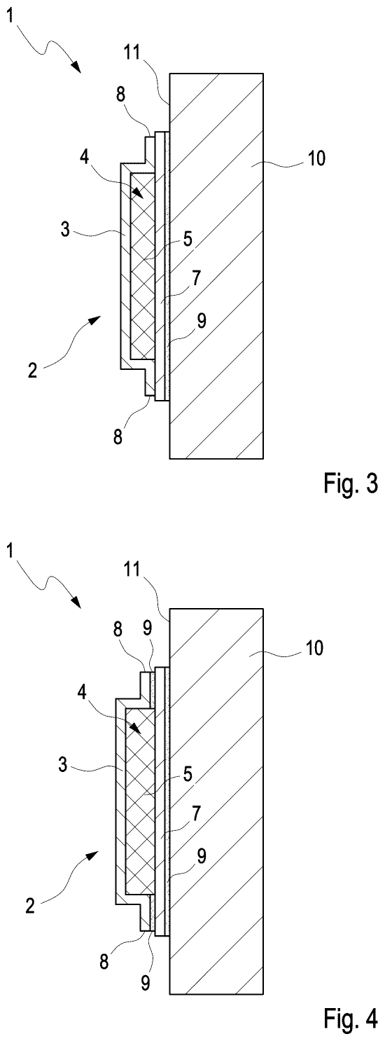

FIG. 3 shows an arrangement 2 according to a second exemplary embodiment of the present disclosure. In contrast to the first exemplary embodiment, cavity 4 is closed fluid-tight even without the interaction of component 10. For this purpose, damping device 2 may have a closure section 7 which may be connected to wall 3 at the edge in order to enclose cavity 4.

Wall 3 and closure section 7 may be welded together along an edge section 8, for example. The entire damping device 2 may then be glued to component 10 by way of one or more adhesive layers 9.

FIG. 4 shows an arrangement 2 according to a third exemplary embodiment according to the present disclosure. In contrast to arrangement 2 of FIG. 3, wall 3 and closure section 7 may be connected to one another by way of adhesive bonds, for example by way of adhesive layers 9, in order to enclose the cavity in a fluid-tight manner. Closure section 7 may thus act as a cover for cavity 4 and may be glued to wall 3 along edge section 8, analogously to FIG. 3.

Damping device 2 may be glued to component 11 via closure section 7.

German patent application no. 102023136214.3 filed Dec. 21, 2023, to which this application claims priority, is hereby incorporated herein by reference, in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An arrangement for at least partially adapting a damping property of a damping device and/or a component, the arrangement comprising:
at least one component;
at least one damping device integrated into the at least one component or connected to the at least one component, the at least one damping device having a wall at least partially defining a closable cavity; and
at least one cavity filling which is arranged in the cavity,
wherein the cavity filling is configured to cause a pressure change and/or a mechanical movement in the cavity as a function of a temperature change.

2. The arrangement according to claim 1, wherein the cavity filling is configured as a phase change material or includes at least one phase change material and/or wherein the cavity filling is configured as a bimetal or includes a bimetal.

3. The arrangement according to claim 1, wherein the wall of the damping device includes several parts, wherein the parts of the wall are connected to one another by a fastening device and/or are materially bonded, wherein the parts of the wall close the at least one cavity with the cavity filling therein in a fluid-tight manner.

4. The arrangement according to claim 1, wherein the wall of the damping device is connected to at least one section of the component, wherein the at least one cavity having the cavity filling therein is closed in a fluid-tight manner by an interaction of the wall of the damping device and the section of the component.

5. The arrangement according to claim 4, wherein the wall of the damping device has a peripheral edge section which is configured to contact the section of the component and/or a closure section of the damping device by a fastening device and/or by being materially bonded, wherein the cavity is configured to be at least partially opened by the wall and is configured to be closed in a fluid-tight manner by the closure section.

6. The arrangement according to claim 5, wherein the wall of the damping device is connected directly to the component by way of an adhesive layer or adhesive film, or wherein the wall of the damping device is connected indirectly to the component via the closure section by way of an adhesive layer or adhesive film.

7. The arrangement according to claim 1, wherein the at least one cavity filling is configured to at least partially undergo a phase transition from liquid to solid, from solid to liquid, from liquid to gaseous, from gaseous to liquid, from solid to gaseous or from gaseous to solid due to a temperature change.

8. The arrangement according to claim 1, wherein the at least one cavity filling is configured to cause a pressure increase or pressure decrease due to a change in a phase state in closed cavity, wherein the closed cavity is fluid-tight.

9. The arrangement according to claim 1, wherein the at least one cavity filling has at least one additive, wherein the at least one additive includes heat-conducting particles.

10. The arrangement according to claim 1, wherein the wall of the damping device is configured as one part, wherein the wall closes the at least one cavity with the cavity filling therein in a fluid-tight manner.

11. A method for damping mechanical vibrations of a component as a function of a temperature, the method comprising:
heating or cooling a component generating and/or transmitting mechanical vibrations directly or indirectly; and
subjecting at least one cavity filling of a damping device connected to the component arranged in a closed cavity to a temperature by the component and/or an environment of the component,
wherein said subjecting of the cavity filling with temperature causes an at least partial change in a phase state of the cavity filling, and
wherein the change in the phase state of the cavity filling changes at least one damping property of the damping device due to a pressure change and/or a mechanical movement of the cavity filling in the cavity.
